(19) United States
(12) Patent Application Publication
(10) Pub. No.: US 2025/0096280 A1
(43) Pub. Date: Mar. 20, 2025

(54) CURRENT COLLECTOR, ELECTRODE AND LITHIUM-ION SECONDARY BATTERY FOR ELECTRICAL STORAGE DEVICE, AND METHOD FOR MANUFACTURING CURRENT COLLECTOR

(71) Applicant: TDK Corporation, Tokyo (JP)

(72) Inventors: Mingyu CHEN, Tokyo (JP); Makoto ENDO, Tokyo (JP); Yoshihiro KANBAYASHI, Tokyo (JP); Takasi SATOU, Tokyo (JP); Natsumi KOZAI, Tokyo (JP); Yoshihiko TANABE, Tokyo (JP); Syuji TSUKAMOTO, Tokyo (JP); Miyuki YANAGIDA, Tokyo (JP)

(73) Assignee: TDK Corporation, Tokyo (JP)

(21) Appl. No.: 18/729,348

(22) PCT Filed: Jan. 17, 2022
(86) PCT No.: PCT/JP2022/001467

§ 371 Date: Jul. 16, 2024

(51) Int. Cl. H01M 4/66; H01M 4/04; H01M 10/0525

(52) U.S. Cl. CPC H01M 4/668; H01M 4/0404; H01M 10/0525

(57) ABSTRACT

A current collector including: a resin layer having first and second surfaces on opposites sides; and a metal layer including copper. The metal layer includes a first metal layer located on a side of the first surface of the resin layer. A yield stress σY1 of the current collector is smaller than a tensile fracture stress σB2 of the resin layer. The yield stress σY1 [MPa] is obtained by expressions (1) and (2) from a resin layer yield stress σY2 [MPa], a resin layer thickness D2 [μm], a yield stress σY3 [MPa] of the metal layer, and a thickness D3 [μm] of the metal layer:

$$σ Y 1 = A \times σ Y 3 + ( 1 - A ) \times σ Y 2 \qquad ( 1 )$$

$$A = D 3 / ( D 2 + D 3 ) . \qquad ( 2 )$$

The yield stress σY3 [MPa] is obtained by the following expression (3) from a half-value width β [°] of an X-ray diffraction peak having the highest intensity in an X-ray diffraction pattern of the metal layer

$$σ Y 3 = ( - 103 + 16 \; 44 \times √ β ) . \qquad ( 3 )$$

### TECHNICAL FIELD

The present disclosure relates to a current collector, an electrode for a power storage device, a lithium ion secondary battery, and a method for manufacturing a current collector.

### BACKGROUND ART

It has been proposed to use a composite material in which metal layers are formed on both surfaces of a resin film as a current collector for a secondary battery (Patent Literature 1).

### CITATION LIST

### Patent Literature

[Patent Literature 1] Japanese Unexamined Patent Publication No. 2014-75191

### SUMMARY OF INVENTION

### Technical Problem

A current collector using a composite material including a resin film and a metal layer is required to have suitable mechanical properties. Embodiments of the present disclosure provide a current collector that can have suitable mechanical properties, and an electrode for a power storage device and a lithium ion secondary battery that use such a current collector.

### Solution to Problem

A current collector according to one embodiment of the present disclosure is a current collector including: a resin layer having a first surface and a second surface located on a side opposite to the first surface; and a metal layer including copper, wherein the metal layer includes a first metal layer located on a side of the first surface of the resin layer, wherein the yield stress σY1 [MPa] of the current collector is a value obtained by the following expressions (1) and (2) from a yield stress σY2 [MPa] of the resin layer, a thickness D2 [μm] of the resin layer, a yield stress σY3 [MPa] of the metal layer, and a thickness D3 [μm] of the metal layer, and

$$σ Y 1 = A \times σ Y 3 + ( 1 - A ) \times σ Y 2 \qquad ( 1 )$$

$$A = D 3 / ( D 2 + D 3 ) \qquad ( 2 )$$

wherein the yield stress σY3 [MPa] of the metal layer is a value obtained by the following expression (3) from a half-value width β [°] of an X-ray diffraction peak having the highest intensity in an X-ray diffraction pattern of the metal layer.

$$σ Y 3 = ( - 103 + 1644 \times √ β ) \qquad ( 3 )$$

### Advantageous Effects of Invention

According to the embodiments of the present disclosure, a current collector that can have suitable mechanical properties, and an electrode for a power storage device and a lithium ion secondary battery that use such a current collector are provided.

### BRIEF DESCRIPTION OF DRAWINGS

FIG. 1 is a schematic cross-sectional view of a current collector according to an embodiment of the present disclosure.

FIG. 2 is a schematic cross-sectional view of another current collector according to the embodiment.

FIG. 3 is a diagram showing a relationship between a half-value width β of an X-ray diffraction peak and a yield stress σY3 of a copper film.

FIG. 4A is a schematic cross-sectional view showing a state in which a tensile load is applied to a current collector of a reference example.

FIG. 4B is a schematic cross-sectional view showing a state in which the tensile load is applied to the current collector of the reference example.

FIG. 4C is a schematic cross-sectional view showing a state in which the tensile load is applied to the current collector of the reference example.

FIG. 5A is a schematic cross-sectional view showing a state in which a tensile load is applied to the current collector of the embodiment.

FIG. 5B is a schematic cross-sectional view showing a state in which the tensile load is applied to the current collector of the embodiment.

FIG. 5C is a schematic cross-sectional view showing a state in which the tensile load is applied to the current collector of the embodiment.

FIG. 6 is a schematic cross-sectional view of a current collector according to a modification example.

FIG. 7 is a schematic cross-sectional view of another current collector according to the modification example.

FIG. 8 is a diagram showing an example of a stress-strain curve of a resin layer used in current collectors of examples and comparative examples.

FIG. 9 is a diagram plot showing a relationship between a thickness proportion A and a half-value width β of a metal layer and a proportion B in the current collectors of the examples and the comparative examples.

FIG. 10A is a diagram showing an example of a stress-strain curve of a current collector of Example 1.

FIG. 10B is a diagram showing an example of a stress-strain curve of a current collector of Comparative Example 1.

FIG. 11A is an exploded perspective view of an electrode for a power storage device according to an embodiment of the present disclosure.

FIG. 11B is a cross-sectional view showing a part of the electrode for a power storage device shown in FIG. 11A.

FIG. 12 is a cross-sectional view showing a part of another electrode for a power storage device.

FIG. 13 is a schematic external view of a lithium ion secondary battery according to an embodiment of the present disclosure.

FIG. 14 is an exploded perspective view showing a cell taken out from the lithium ion secondary battery shown in FIG. 13.

FIG. 15 is a schematic external view of another lithium ion secondary battery.

FIG. 16 is an exploded perspective view showing a cell taken out from the lithium ion secondary battery shown in FIG. 15.

### DESCRIPTION OF EMBODIMENTS

Hereinafter, embodiments of the present disclosure will be described with reference to the drawings. A current collector, an electrode for a power storage device, and a lithium ion secondary battery which will be described below are intended to embody the technical concept of the present invention, and unless otherwise specified, the present invention is not limited to the following. Furthermore, the contents which will be described in one embodiment are applicable to other embodiments and modification examples. Furthermore, the sizes, the positional relationships, or the like of members shown in the drawings may be exaggerated for clarity of explanation.

In the following description, constituent elements having substantially the same functions are denoted by a common reference sign, and the description thereof may be omitted. Furthermore, in the present disclosure in which reference signs may not be given to constituent elements that are not referred to in the description, unless otherwise specified, “parallel” includes a case in which two straight lines, sides, surfaces, or the like are in the range of being at approximately 0° to +5° from each other. In addition, in the present disclosure, unless otherwise specified, “perpendicular” or “orthogonal” includes a case in which two straight lines, sides, surfaces, or the like are in the range of being at approximately ±5° to 90° from each other.

The numerical values, the shapes, the materials, the steps, the order of the steps, and the like presented in the following description are merely examples, and various modifications are possible as long as no technical contradiction occurs. Furthermore, the embodiments which will be described below are merely examples, and various combinations are possible as long as no technical contradiction occurs.

The dimensions, the shape, and the like of each of the members shown in the drawings of the present disclosure may be exaggerated for the convenience of explanation. In addition, in the drawings of the present disclosure, some members may be shown in a state of being taken out or some elements may be omitted in order to avoid excessive complexity. For this reason, the dimensions of each of the members shown in the drawings of the present disclosure and the arrangement of the members may not reflect the dimensions of each of members in an actual device and the arrangement of the members. In the present specification, terms including “upper” or “lower,” such as “an upper surface,” “a lower surface,” “an upper layer,” and “a lower layer,” may be used. However, these terms are used merely for ease of understanding a relative direction or position in the referenced drawings. In drawings other than those of the present disclosure, an actual product, a manufacturing apparatus, or the like, as long as the relative direction or positional relationship using the terms such as “upper” and “lower” is the same as in the referenced drawings, the arrangement does not have to be the same as in the referenced drawings.

In the present specification, the term “cell” refers to a structure in which at least a pair of positive and negative electrodes are integrally assembled. In the present specification, the term “battery” is used as a term that encompasses various forms such as a battery module and a battery pack, having one or more “cells” electrically connected to each other.

### First Embodiment

When manufacturing a secondary battery, treatment that involves a change in volume of the current collector, such as a current collector transport step and a calendering treatment step, is usually carried out. When such treatment causes a tear or a fracture in the current collector, this can lead to an increase in a process defect rate. Furthermore, during operation of the secondary battery, the current collector is also subjected to stress from an active material which expands and contracts as the secondary battery is charged and discharged. For this reason, the current collector is required to have suitable mechanical properties.

As a result of various investigations, the present inventors have found that in a current collector using a composite material including a resin layer and a metal layer, by increasing the elongation rate (the fracture elongation) of the current collector, it is possible to suppress the fracture or the like of the current collector during manufacturing or during battery operation. On the basis of this knowledge, a novel current collector structure capable of increasing the fracture elongation was investigated, and the present inventors have arrived at the embodiments of the present disclosure.

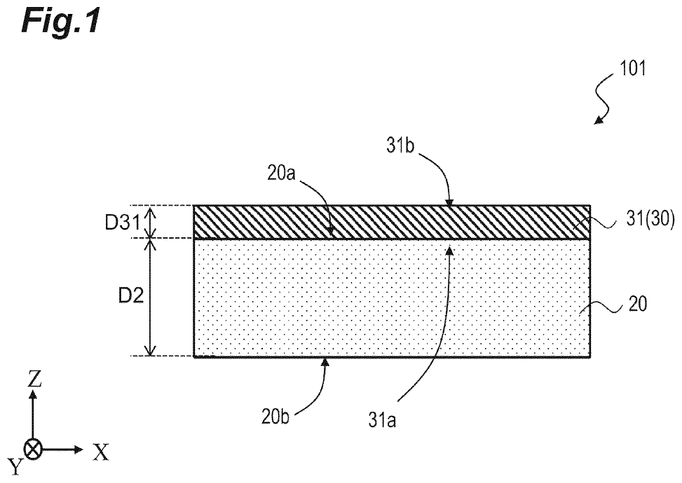

FIG. 1 is a schematic cross-sectional view showing an example of a current collector according to the present embodiment. The current collector of the present embodiment can be used as a current collector for either a positive electrode or a negative electrode of a power storage device such as a lithium ion secondary battery. For ease of explanation, arrows indicating three directions which are orthogonal to each other, that is, an X direction, a Y direction, and a Z direction, are shown in FIG. 1. FIG. 1 shows a cross section perpendicular to the Y direction.

A current collector 101 shown in FIG. 1 includes a resin layer 20 and at least one metal layer 30 including copper. The resin layer 20 and the at least one metal layer 30 are laminated in the thickness direction of the resin layer 20 (here, the Z direction).

The resin layer 20 functions as a support for the metal layer 30 in the current collector 101. The resin layer 20 has a first surface 20a and a second surface 20b located on a side opposite to the first surface 20a. The resin layer 20 has a thickness D2. In the present specification, the thickness of each layer refers to an average distance in the Z direction between the upper surface and the lower surface of that layer. In other words, the thickness D2 of the resin layer 20 is an average distance between the first surface 20a and the second surface 20b.

At least one metal layer 30 includes a first metal layer 31 located on a side of the first surface 20a of the resin layer 20. The first metal layer 31 has a first surface 31a located on a side of the resin layer 20 and a second surface 31b located on a side opposite to the first surface 31a. The first metal layer 31 has a thickness D31.

In the illustrated example, the upper surface of the current collector 101 is the second surface 31b of the first metal layer 31, and the lower surface of the current collector 101 is the second surface 20b of the resin layer 20. The current collector 101 can further include layers other than the first metal layer 31 and the resin layer 20.

The current collector 101 of the present embodiment is configured such that a yield stress σY1 of the current collector 101 is smaller than a tensile fracture stress σB2 of the resin layer 20. The tensile fracture stress σB2 was measured in accordance with the provisions of JIS K 7127:1999.

The yield stress σY1 of the current collector 101 is a value obtained by the following expression (1) from a yield stress σY2 of the resin layer 20, a yield stress σY3 of the metal layer 30, and a thickness proportion A of the metal layer 30. In the present specification, “x” represents multiplication.

$$σ Y 1 = A \times σ Y 3 + ( 1 - A ) \times σ Y 2 \qquad ( 1 )$$

σY1 [MPa]: yield stress of current collector 101
σY2 [MPa]: yield stress of resin layer 20
σY3 [MPa]: yield stress of metal layer 30
A [−]: thickness proportion of metal layer 30

The yield stress σY2 of the resin layer 20 in expression (1) is a tensile yield stress measured in accordance with the provisions of JIS K 7127:1999.

The thickness proportion A of the metal layer 30 in expression (1) is the proportion of a thickness D3 of the metal layer 30 to the total thickness of the resin layer 20 and the metal layer 30 and is a value obtained by the following expression (2).

$$A = D 3 / ( D 2 + D 3 ) \qquad ( 2 )$$

In the example of FIG. 1, the value of the thickness proportion A is calculated as D31/(D2+D31).

The yield stress σY3 [MPa] of the metal layer 30 in expression (1) is a value obtained by the following expression (3) from a half-value width β [°] of an X-ray diffraction peak having the highest intensity in an X-ray diffraction pattern of the metal layer 30 (hereinafter simply referred to as a “half-value width”). In a case in which the metal layer 30 is a copper layer, the X-ray diffraction peak having the highest intensity is, for example, an X-ray diffraction peak of a (111) plane.

$$σ Y 3 = ( - 103 + 16 \; 44 \times √ β ) \qquad ( 3 )$$

The present inventors have derived expression (3) by focusing on the crystallinity of the metal layer and measuring the relationship between the crystallinity and the yield stress of the metal layer. When expression (3) is used, the yield stress σY3 of the metal layer 30 can be calculated by performing X-ray diffraction on the metal layer 30. A method of deriving expression (3) will be described below.

Since the current collector 101 shown in FIG. 1 has only the first metal layer 31 as the metal layer 30, in the above expressions (1) to (3), the yield stress σY3 of the metal layer 30 is the yield stress of the first metal layer 31, and the “thickness D3 of the metal layer 30” is the thickness D31 of the first metal layer 31 (D3=D31). The current collector of the present embodiment may have two or more metal layers, each of which includes copper. In that case, the thickness D3 in the above expression (2) is the total thickness of those metal layers.

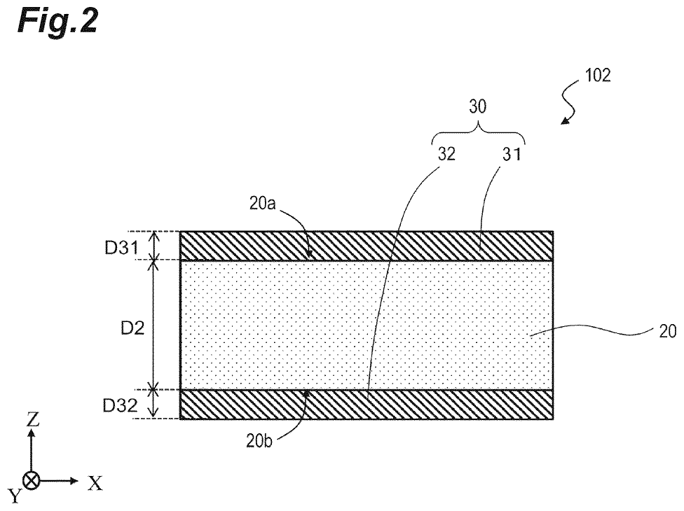

FIG. 2 is a schematic cross-sectional view showing another example of the current collector according to the present embodiment. A current collector 102 shown in FIG. 2 differs from the current collector 101 shown in FIG. 1 in that the current collector 102 further includes a second metal layer 32 located on a side of the second surface 20b of the resin layer 20. Such a current collector 102 can be used, for example, in a laminated type cell.

In the current collector 102, the first metal layer 31, the resin layer 20, and the second metal layer 32 are laminated in the Z direction. The second metal layer 32 includes copper. The material of the second metal layer 32 is the same as the material of the first metal layer 31, for example. The material of the second metal layer 32 may be different from the material of the first metal layer 31 as long as the material of the second metal layer 32 includes copper. The second metal layer 32 has a thickness D32. The thickness D32 may be the same as or different from the thickness D31 of the first metal layer 31.

The current collector 102 is also configured such that the yield stress σY1 obtained by the above expressions (1) to (3) is smaller than the tensile fracture stress σB2 of the resin layer 20. Here, the thickness D3 of the metal layer 30 in expression (2) is the sum of the thickness D31 of the first metal layer 31 and the thickness D32 of the second metal layer 32 (D3=D31+D32). Furthermore, in a case in which the second metal layer 32 is formed under the same conditions using the same material as the first metal layer 31 and the crystallinities of the second metal layer 32 and the first metal layer 31 are considered to be approximately the same (that is, the half-widths β are considered to be approximately the same), the half-value width obtained by X-ray diffraction of the first metal layer 31 or the second metal layer 32 may be used as the half-value width β of the metal layer 30 in expression (3).

### <Relational Expression Between Yield Stress and Half-Value Width of Metal Layer>

The method by which the present inventors have derived the above expression (3) will be described.

The metal such as copper is a typically polycrystalline metal consisting of a plurality of crystal grains. It is known that in a polycrystalline substance, the crystal grain size has a significant effect on the yield strength of the polycrystalline substance, and the smaller the crystal grain size (in other words, the greater the proportion of crystal grain boundaries), the higher the yield strength. The relationship between the yield stress and the crystal grain size is expressed by a Hall-Petch relationship below.

$${σ}_{y} = {σ}_{0} + k {d}^{- 1 / 2}$$

Here, σ_{y} is a yield stress, σ₀ is a friction stress, k is a constant indicating a resistance to slip of the crystal grain boundary, and d is a crystal grain size. The relationship between the yield stress and the crystal grain size of copper or a copper alloy is also known to follow the Hall-Petch relationship.

The present inventors have derived, from experimental results which will be shown below, a relational expression between the yield stress σY3 (corresponding to the yield stress σ_{y} in the Hall-Petch relationship) of the metal layer and the half-value width β of the X-ray diffraction peak having the highest intensity in the X-ray diffraction pattern of the metal layer in the current collector including the resin layer and the metal layer. It is known that the half-value width β of the metal layer is inversely proportional to the crystal grain size (the crystallite size) of the metal layer (a Scherrer equation).

The experimental methods carried out by the present inventors and the experimental results will be described below.

First, a plurality of current collector samples having the structure shown in FIG. 2, for example, were produced using copper films having different crystallinities. Each current collector sample was produced by forming a copper film on each of both surfaces of the resin layer by electrolytic plating. As the resin layer, a polyethylene terephthalate (PET) film having a thickness of 4.5 μm was used. The thickness of each copper film was set to 1.0 μm.

Next, the copper film of each current collector sample was subjected to X-ray diffraction measurement, and the half-value width β of the X-ray diffraction peak having the highest intensity was determined. Further, a tensile test was carried out on each current collector sample in accordance with the provisions of JIS K 7127:1999 to obtain a stress-strain curve. Next, a portion dependent on the PET film was subtracted from the stress-strain curve of the current collector sample to obtain the stress-strain curve of the copper film alone, thereby obtaining the yield stress σY3 of the copper film.

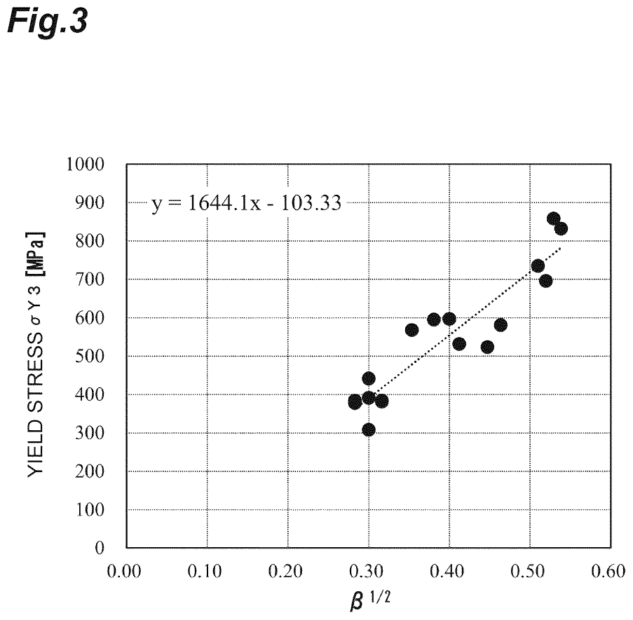

FIG. 3 is a diagram in which the relationship between the half-value width β and the yield stress σY3 of the copper film in each current collector sample is plotted. A horizontal axis represents a positive square root of the half-value width β [°], and a vertical axis represents the yield stress σY3 [MPa]. From the results shown in FIG. 3, it was confirmed that the larger the half-value width β, that is, the smaller the crystallite size, the larger the yield stress σY3. Moreover, the measured value of the yield stress σY3 is roughly proportional to the square root of the half-value width β (√β). This tendency is similar to the Hall-Petch relationship mentioned above.

On the basis of the results shown in FIG. 3, the relational expression between the square root of the half-value width β (√β) and the yield stress σY3 was calculated by linear regression, and the following expression (3) was obtained. Although a copper film was used in the above experiment, as long as a metal film including copper is used, it is possible to obtain the yield stress σY3 using this expression.

$$σ Y 3 = ( - 103 + 16 \; 44 \times √ β ) \qquad ( 3 )$$

### Effects

The current collector 101 or 102 of the present embodiment is configured such that the yield stress σY1 obtained by the above expressions (1) to (3) is smaller than the tensile fracture stress σB2 of the resin layer 20. By satisfying the relationship σY1<σB2, the elongation rate (the fracture elongation) of the current collector 101 or 102 can be increased, as will be described below. For example, the fracture elongation of the current collector 101 or 102 can be increased to the same extent as the fracture elongation of the resin layer 20 at the maximum. This makes it possible to suppress a fracture of the current collector 101 or 102 during the current collector transport step and the calendering treatment step in manufacturing an electrode for a power storage device, thereby improving the process defect rate. Furthermore, in a secondary battery using the current collector 101 or 102, even in a case in which a large force is applied locally to the current collector 101 or 102 due to the expansion and contraction of the active material during charging and discharging, deformation of the battery, deterioration of the battery characteristics (an increase of the resistance) and/or variation in characteristics caused by the fracture or the tear of the current collector 101 or 102 can be suppressed. In the present specification, “a fracture occurs in the current collector” refers to a state in which a fracture or tear occurs across the entire thickness of the current collector, including the metal layer and the resin layer, and does not include, for example, a state in which a fracture portion occurs only in the metal layer. In addition, “a fracture occurs in the current collector” includes a state in which the fracture portion or the tear is formed in a part of the current collector across the thickness direction of the current collector, and does not necessarily mean that the current collector (for example, a current collector constituting a battery) is completely separated into two or more portions. Among the fracture portions of the current collector, a fracture portion that extends linearly in a plan view is sometimes called a “tear.”

The fracture elongation of the current collector 101 or 102 is not particularly limited, but may be greater than the fracture elongation of the metal layer 30 (for example, about 3% to 5%) and equal to or less than the fracture elongation of the resin layer 20. The fracture elongation of the current collector 101 or 102 is preferably greater than 6%, for example, and may be 20% or more, for example.

### <Relationship Between Yield Stress σY1, Tensile Fracture Stress σB2, and Fracture Elongation of Current Collector>

With reference to the drawings, the reason why the elongation rate (the fracture elongation) of the current collector can be increased by making the yield stress σY1 of the current collector smaller than the tensile fracture stress σB2 of the resin layer will be described.

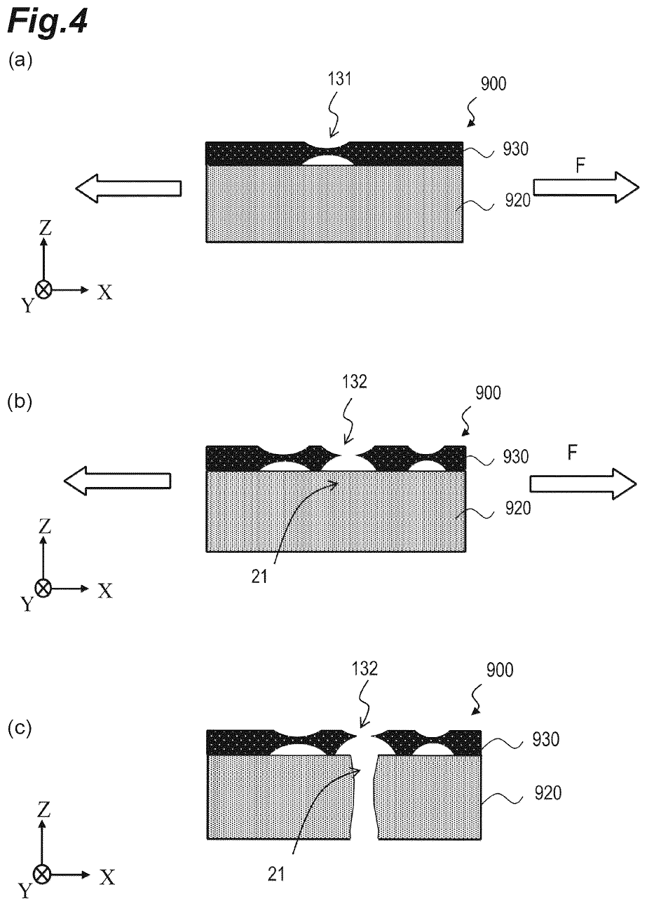

FIGS. 4A to 4C are enlarged cross-sectional views schematically illustrating states of a metal layer 930 and a resin layer 920 when a tensile load is applied to a current collector 900 of a reference example in which the yield stress σY1 is greater than the tensile fracture stress σB2 of the resin layer 920 (σY1>σB2).

As shown in FIG. 4A, a tensile load F is applied to the current collector 900 in an X-axis direction shown in the figure. As the tensile load F is increased, the metal layer 930 is partially thinned, and thus a necked portion 131 is formed. This phenomenon is called “necking” or a “necking phenomenon.” The necking can occur, for example, in a portion at which the adhesion between the metal layer 930 and the resin layer 920 is low. Furthermore, in the portion at which the necking occurs, a crack that extends in a direction intersecting with the X-axis direction (for example, a direction approximately parallel to a Y-axis direction) can occur on the upper surface of the metal layer 930.

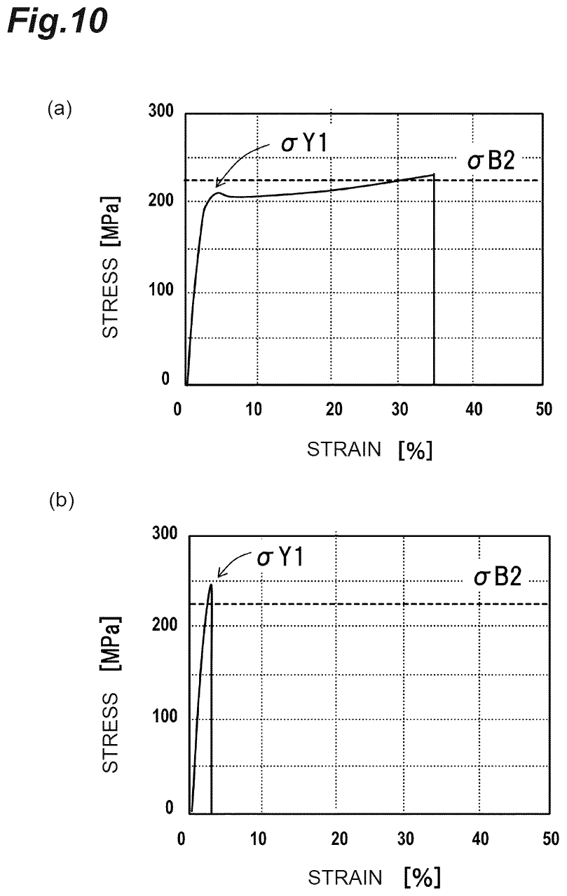

Thereafter, when the tensile load F is further increased, the necking progresses as shown in FIG. 4B, and when the stress applied to the current collector 900 reaches the yield stress σY1 of the current collector 900, the fracture occurs in the necked portion 131 of the metal layer 930 (in other words, the time point at which the fracture occurs is the yield point of the current collector 900). Immediately after the fracture has occurred in the metal layer 930, the entire load that was applied to the necked portion 131 is applied to a portion 21 of the resin layer 920 that is located below a fracture portion 132. In the current collector 900, the yield stress σY1 is greater than the tensile fracture stress σB2 of the resin layer 920, and thus immediately after the metal layer 930 has broken, a stress that exceeds the tensile fracture stress σB2 is applied to the portion 21 of the resin layer 920. As a result, as shown in FIG. 4C, the portion 21 of the resin layer 920 can also fracture, and the fracture can occur in the current collector 900 (see a stress-strain curve in FIG. 10B).

In this way, in the current collector 900 of the reference example, at the time point at which the fracture portion 132 occurs in the metal layer 930 (that is, the current collector 900 yields), the current collector 900 fractures without elongation, and therefore the fracture elongation of the current collector 900 is considered to be small.

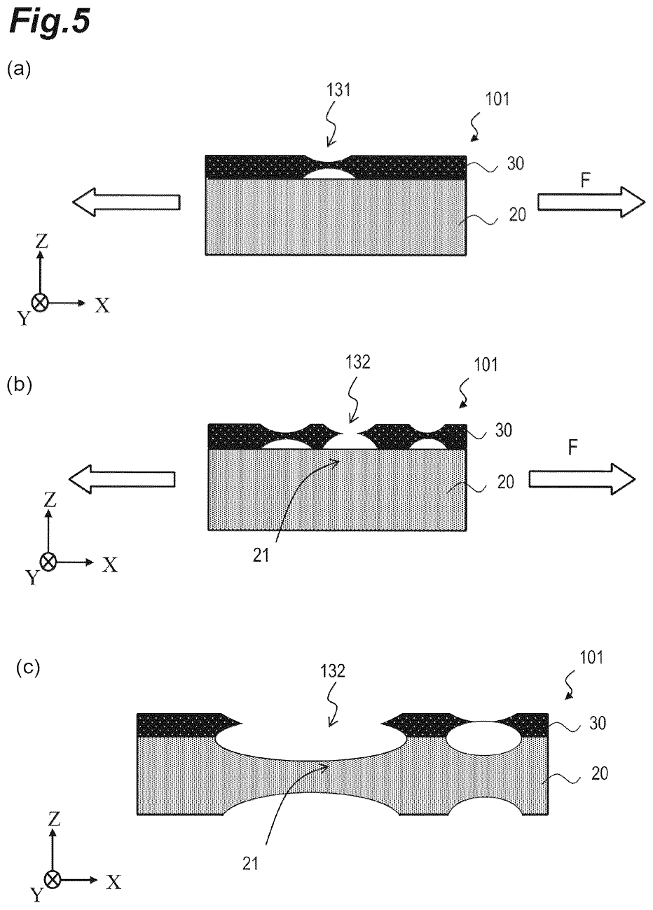

FIGS. 5A to 5C are enlarged cross-sectional views schematically illustrating states of the metal layer 30 and the resin layer 20 when a tensile load is applied to the current collector 101 in which the yield stress σY1 is set to be smaller than the tensile fracture stress σB2 of the resin layer 20.

As shown in FIGS. 5A and 5B, when a tensile load F is applied to the current collector 101, similarly to the current collector 900 of the reference example, the necked portion 131 is first formed in the metal layer 30. When the stress applied to the current collector 101 by the tensile load F reaches the yield stress σY1, the fracture can occur in the necked portion 131. In the current collector 101, the stress applied to the portion 21 of the resin layer 20 immediately after the fracture portion 132 has occurred is smaller than the tensile fracture stress σB2 of the resin layer 20, and thus at this time point, the fracture does not occur in the resin layer 20. As shown in FIG. 5C, as the tensile load F increases, the resin layer 20 elongates further in the X-axis direction. Therefore, the current collector 101 has a higher fracture elongation than the current collector 900 of the reference example shown in FIGS. 4A to 4C.

The resin layer 20 can be stretched without the fracture, for example, until the stress applied to the portion 21 of the resin layer 20 reaches the tensile fracture stress σB2 (see a stress-strain curve in FIG. 10A). Therefore, the current collector 101 can have a fracture elongation that is approximately equal to the fracture elongation of the resin layer 20 at the maximum.

In the above, it has been explained how the necking and the fracture of the metal layer occur due to the tensile load on the current collector, and that the necking can occur at a position at which the adhesion between the metal layer and the resin layer is low. This is based on the findings obtained by the present inventors by repeatedly performing the tensile tests on the current collector including the resin layer and the metal layer and observing the upper surface and the cross section of the current collector after the tests.

In the above, the current collectors 101 and 900 in which the metal layer 30 is disposed on only one surface of the resin layer 20 have been described as examples, but the same tendency can be obtained even when the metal layers are disposed on both surfaces of the resin layer 20.

In the current collector 900 of the reference example, a minute fracture can occur in the metal layer 930 and the fracture can occur in the resin layer 920 serving as a base material at approximately the same time. Therefore, for example, during a calendering treatment in manufacturing a battery, the current collector 900 may be torn across its entire thickness, resulting in a process defect. Similarly, when the battery is in operation, the stress from the active material may cause the metal layer 930 and the resin layer 920 to fracture, resulting in a deterioration in the battery characteristics (for example, an increase of the resistance) or deformation of the electrodes. In contrast, according to the current collector 101 of the present embodiment, even when a minute fracture portion occurs in the metal layer 30 during the calendering treatment, the resin layer 20 does not fracture at the same time, and the tear of the current collector 101 is suppressed, and thus a process defect is less likely to occur. Similarly, even in a case in which a minute fracture portion occurs in the metal layer 30 when the battery is in operation, a deterioration of the battery characteristics and deformation of the electrodes can be kept small compared to the reference example.

### <Stress and Thickness of Each Layer>

In the present embodiment, the mechanical properties (the yield stress, the tensile fracture stress) of the resin layer, the crystallinity of the metal layer, and the thickness proportion A are set such that the yield stress σY1 is smaller than the tensile fracture stress σB2 of the resin layer (σY1<σB2). The current collector of the present embodiment can be manufactured by controlling a film structure, a material, a thickness, a formation method, or the like of each layer constituting a laminated structure. These control factors are interrelated. For example, if the thickness of the metal layer varies, the appropriate conditions for forming the metal layer and the appropriate thickness of the resin layer can vary.

Usually, when designing a current collector, in order to ensure sufficient electrical properties, it is considered that a relatively thick metal layer is often used or the thickness proportion A of the metal layer to the entire thickness of the current collector is often increased. In this case, the thickness proportion A of the metal layers in expression (2) becomes large. Then, the term “A×σY3′ in expression (1) becomes large, and thus it is difficult to make the yield stress σY1 of the current collector smaller than the tensile fracture stress σB2 of the resin layer. In contrast, in the present embodiment, attention is focused on the crystallinity of the metal layer 30, and the current collector is designed to satisfy the relationship σY1<σB2. For example, by forming the metal layer 30 having a relatively large crystallite size (in other words, a small half-value width β) and not increasing the thickness of the metal layer 30, the term “A×σY3” in expression (1) can be reduced. As a result, it is possible to satisfy the relationship σY1<σB2, thereby obtaining a high fracture elongation. Furthermore, the metal layer 30 having a small half-value width β has excellent crystallinity and can have a low electrical resistance (sheet resistance). Therefore, even in a case in which the thickness of the current collector 101 or 102 is reduced in order to increase the fracture elongation, sufficient electrical properties can be ensured.

Hereinafter, with reference again to FIGS. 1 and 2, examples of the stress and the thickness of each layer constituting the current collector 101 or 102 will be described in more detail.

In the current collector 101 or 102 of the present embodiment, the yield stress σY2, the tensile fracture stress σB2, and the thickness D2 of the resin layer 20, the thickness proportion A of the metal layer 30, the thickness D3 of the metal layer 30, and the like are not particularly limited as long as they are set to satisfy σY1<σB2.

As an example, the thickness D2 of the resin layer 20 may be, for example, 3 μm or more, and preferably 4 μm or more. As a result, it is possible to more reliably ensure the strength of the current collector 101 or 102. Furthermore, by making the resin layer 20 thick, the thickness proportion A of the metal layer 30 can be easily adjusted to fall within a desired range. On the other hand, from the viewpoint of improving the energy density, the thickness of the resin layer 20 may be, for example, 12 μm or less, and preferably 6 μm or less.

The yield stress σY2 of the resin layer 20 may be, for example, 120 MPa or less. The tensile fracture stress σB2 may be, for example, 150 MPa or more.

The thickness (the total thickness) D3 of the metal layer 30 may be, for example, 0.1 μm or more. As a result, the sheet resistance can be more lowered. On the other hand, the thickness D3 of the metal layer 30 may be, for example, 6 μm or less, and preferably 3 μm or less. As a result, it is possible to suppress an increase in the weight of the current collector 101. In addition, the thickness proportion A of the metal layer 30 can be easily adjusted to a desired range. The thickness D3 of the metal layer 30 may be smaller than the thickness D2 of the resin layer 20. In a case in which as the metal layer 30, the first metal layer 31 and the second metal layer 32 are provided on both sides of the resin layer 20, the thickness of each of the first metal layer 31 and the second metal layer 32 may be, for example, 0.05 μm or more and 1.5 μm or less.

The half-value width β of the X-ray diffraction peak having the highest intensity in the X-ray diffraction pattern of the metal layer 30 may be, for example, 0.33° or less, and more preferably 0.25° or less. The larger the crystal grain size (the crystallite size) of the metal layer 30, the smaller the half-value width β (the Scherrer equation). The yield stress of the metal layer 30 is considered to follow the Hall-Petch relationship discussed above. From this, it is considered that the larger the crystallite size in the metal layer 30, in other words, the smaller the half-value width β, the smaller the yield stress σY3 of the metal layer 30. Therefore, by setting the half-value width β to 0.33° or less, and preferably 0.25° or less, the yield stress σY1 of the current collector obtained from expression (1) can be easily set to be smaller than the tensile fracture stress σB2 of the resin layer. On the other hand, the half-value width β may be, for example, 0.08° or more. As a result, it is possible to suppress a decrease in sheet resistance caused by deformation (plastic deformation), a crack, or the like in the metal layer 30.

The thickness proportion A of the metal layer 30 may be, for example, 0.44 or less. As a result, it is possible to make the yield stress σY1 of the current collector 101 or 102 to be small, and thus it is easy to increase the fracture elongation. In addition, it is possible to suppress an increase in the weight of the current collector 101 or 102. On the other hand, the thickness proportion A of the metal layer 30 may be, for example, 0.02 or more. If the thickness proportion A of the metal layer 30 is 0.02 or more, the sheet resistance of the metal layer 30 can be reduced.

### <Resin Layer 20>

The resin layer 20 is, for example, a sheet in which a thermoplastic resin is set as a base material. A polyester-based resin, a polyamide-based resin, a polyethylene-based resin, a polypropylene-based resin, a polyolefin-based resins, a polystyrene-based resin, a phenol-based resin, a polyurethane-based resin, an acetal-based resin, cellophane, an ethylene-vinyl alcohol copolymer (EVOH), polyethylene terephthalate, polystyrene (PS), polyimide, polyvinyl chloride, or the like can be used as the base material for the resin layer. Examples of the polyolefin-based resin include polyethylene (PE), polypropylene (PP), and the like. The polyolefin-based resin may be an acid-modified polyolefin-based resin. Examples of the polyester-based resin include polybutylene terephthalate (PBT), polyethylene naphthalate, and the like. Examples of the polyamide-based resin include nylon 6, nylon 66, polymetaxylylene adipamide (MXD6), and the like. For example, a uniaxially stretched sheet or biaxially stretched sheet of polyethylene terephthalate, or a biaxially stretched sheet of polypropylene can be suitably used for the resin layer.

In the present embodiment, the resin layer 20 includes at least any one of polyethylene terephthalate, polyimide, polypropylene, polycarbonate, polyamide, and polyvinyl chloride, for example.

The resin layer 20 is not limited to a single layer film. The resin layer 20 may have a laminated structure including a plurality of resin films. In a case in which the resin layer 20 has the laminated structure, the tensile fracture stress and the yield stress of the thickest main layer in the laminated structure can be used as the tensile fracture stress σB2 and the yield stress σY2 of the resin layer 20. Alternatively, as the yield stress σY2 (or the tensile fracture stress σB2) of the resin layer 20, a value obtained by weighting the yield stresses (or the tensile stresses) of the layers constituting the resin layer 20 by proportions of the thicknesses and adding them up may be used. For example, the yield stress of the entire resin layer 20 can be obtained as the sum of “(ratios to the thickness of the entire resin layer 20)×yield stresses” of the layers constituting the resin layer 20.

### <Metal Layer 30>

The metal layer 30 preferably includes copper as a main component. The term “including copper as a main component” includes those in which the content of copper in the metal layer is greater than 50% by weight. The content of copper in the metal layer 30 may be 80% by weight or more. The metal layer 30 may include an alloy in which copper is a main component. Examples of the metal layer 30 include a copper layer, a copper alloy layer such as Cu—Sn or Cu—Ni, and the like.

The metal layer 30 preferably has a low sheet resistance. The sheet resistance is, for example, 60 mΩ/□ or less, and preferably 30 mΩ/□ or less.

The metal layer 30 may include a plurality of metal films having different materials, compositional proportions, formation methods, and the like. In a case in which the metal layer 30 includes a plurality of metal films with different crystallinities, the yield stress of the metal layer 30 may be obtained by weighting the yield stresses of the metal films included in the metal layer 30 by proportions of the thicknesses and adding them up.

For example, the first metal layer 31 and the second metal layer 32 may be formed from different materials. In that case, the yield stress σY3 of the metal layer 30 can be obtained, for example, from the following expressions (4) and (5) using the yield stress σY31 of the first metal layer 31 obtained from the half-value width β of the first metal layer 31 and the yield stress σY32 of the second metal layer 32 obtained from the half-value width β of the second metal layer 32.

$$σ Y 3 = B \times σ Y 31 + ( 1 - B ) \times σ Y 32 \qquad ( 4 )$$

$$B = D 31 / ( D 31 + D 32 ) \qquad ( 5 )$$

The first metal layer 31 and/or the second metal layer 32 may be a single layer film or a laminated film. In a case in which each of the first metal layer 31 and the second metal layer 32 has a laminated structure, the yield stress of the thickest main layer in the laminated structure of the metal layer 31 or 32 may be used as the yield stress σY31 or σY32 in the above expression (4).

An undercoat layer or the like may be interposed between the first metal layer 31 or the second metal layer 32 and the resin layer 20. In addition, a protective layer or the like may be provided on the surface of the first metal layer 31 or the second metal layer 32.

### Modification Example

The current collector of the present embodiment may further include another solid layer located between the resin layer and the metal layer. Such a solid layer is called an “intervening layer.”

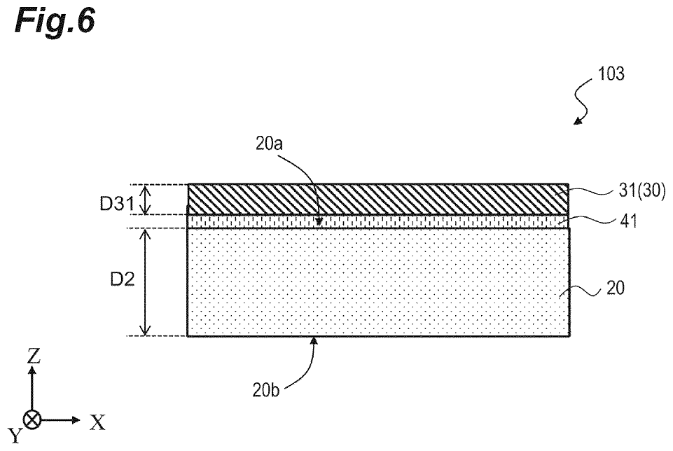

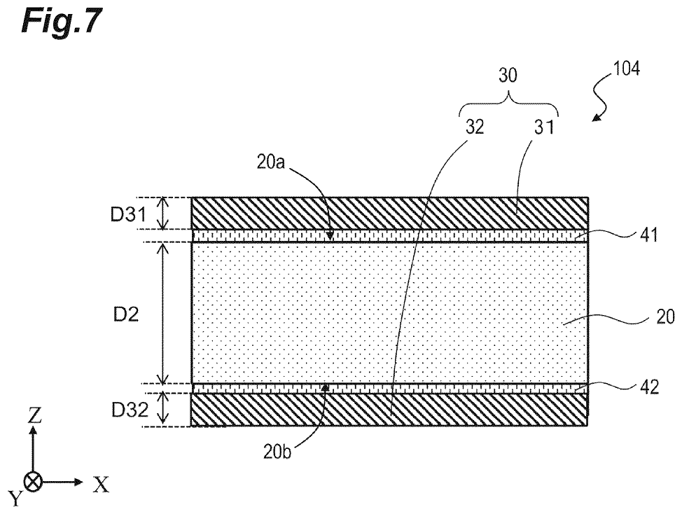

FIGS. 6 and 7 are schematic cross-sectional views showing other examples of the current collector according to the present embodiment.

A current collector 103 shown in FIG. 6 differs from the current collector 101 shown in FIG. 1 in that the current collector 103 further includes a first intervening layer 41 between the first surface 20a of the resin layer 20 and the first metal layer 31.

The first intervening layer 41 includes a metal other than copper as a main component. The intervening layer 41 may be a single layer film or a laminated film. The intervening layer 41 may be, for example, an undercoat layer or an anchor coat layer for strengthening the bond between the resin layer 20 and the metal material. The undercoat layer or the anchor coat layer may be an organic layer such as a layer formed of an acrylic resin or a polyolefin resin, or may be a metal layer formed by a sputtering method or the like. By providing the undercoat layer, the bond between the first metal layer 31 and the resin layer 20 can be strengthened, which has the effect of increasing adhesion and/or the effect of suppressing the formation of pinholes in the first metal layer 31.

A current collector 104 shown in FIG. 7 differs from the current collector 102 shown in FIG. 2 in that the current collector 104 further includes a first intervening layer 41 located between the first surface 20a of the resin layer 20 and the first metal layer 31, and a second intervening layer 42 located between the second surface 20b of the resin layer 20 and the second metal layer 32.

Each of the first intervening layer 41 and the second intervening layer 42 includes a metal other than copper as a main component. The materials and functions of the first intervening layer 41 and the second intervening layer 42 may be similar to those of the first intervening layer 41 of the current collector 103 shown in FIG. 6. The materials of the first intervening layer 41 and the second intervening layer 42 may be the same or different from each other.

The thicknesses of the first intervening layer 41 and the second intervening layer 42 in the current collectors 103 and 104 are appropriately selected depending on the function of the intervening layer, and are not particularly limited. The first intervening layer 41 is preferably thinner than each of the resin layer 20 and the first metal layer 31. Similarly, the second intervening layer 42 is preferably thinner than each of the resin layer 20 and the second metal layer 32. The thickness of the first intervening layer 41 and the thickness of the second intervening layer 42 may be the same or different from each other.

The current collector of the present modification example only needs to include at least one intervening layer located between the resin layer 20 and the metal layer 30. For example, the current collector of the present modification example may have an intervening layer between only any one of the first metal layer 31 and the second metal layer 32 and the resin layer 20.

In the present modification example, the thickness (the total thickness) D4 of the intervening layer(s) in the current collector may satisfy, for example, the following expression.

$$D 4 / ( D 2 + D 3 + D 4 ) < 0.02$$

The thickness D4 in the above expression is the total thickness of the intervening layers in the current collector. In other words, in the current collector 103, the thickness D4 is the thickness of first intervening layer 41, and in the current collector 104, the thickness D4 is the total thickness of the first intervening layer 41 and the second intervening layer 42. When the above expression is satisfied, the effect of the intervening layer on the yield stress of the current collector 103 or 104 is reduced, and thus the fracture elongation of the current collector 103 or 104 can be more reliably improved by designing using the above expressions (1) and (2).

### (Method for Manufacturing Current Collector)

The method for manufacturing a current collector of the present embodiment will be described more specifically using the current collector 102 shown in FIG. 2 as an example.

### <Production of Current Collector>

First, the resin layer 20 is prepared. The resin layer 20 is, for example, a polyethylene terephthalate film.

Next, the metal layer 30 is formed on the surface of the resin layer 20. The metal layer 30 can be formed by a known semiconductor process. For example, vapor deposition, sputtering, electrolytic plating, nonelectrolytic plating, or the like may be used. For example, the metal layer 30 may be formed by forming a seed layer on the surface of the resin layer and then forming a copper film on the seed layer by electrolytic plating. Alternatively, as the metal layer 30, a metal foil including copper, such as a copper foil, may be attached to the surface of the resin layer 20.

Here, the first metal layer 31 is formed on the first surface 20a of the resin layer 20, and the second metal layer 32 is formed on the second surface 20b of the resin layer 20. As the first metal layer 31 and the second metal layer 32, for example, a copper film is formed. A seed layer of nickel chromium (NiCr) or copper may be formed on both surfaces of the resin layer 20 by, for example, sputtering, and then a copper film may be formed on the seed layer by electrolytic plating.

The formation conditions and thicknesses of the metal films that become the first metal layer 31 and the second metal layer 32 can be adjusted such that the yield stress σY1 obtained by expressions (1) to (3) is smaller than the tensile fracture stress σB2 of the resin layer 20. In the case of vapor deposition, the formation conditions of the metal film include the substrate temperature during vapor deposition, the purity of the vapor deposition material, the vapor deposition rate, the vapor deposition time, and the like. In the case of plating, the formation conditions of the metal film include the current density, the growth rate, the plating time, the material for the underlying seed layer, the formation conditions of the seed layer, the type and amount of the additive agent, and the like. In the case of sputtering, the formation conditions of the metal film include the purity of the target, the ultimate vacuum in the chamber, the sputtering atmosphere, the sputtering pressure, the sputtering power, the film formation rate, the substrate temperature, and the film formation time.

As an example, the half-value width β of the metal film can be reduced (the crystal grain size can be increased) by setting the plating current density to be high when the metal film is formed and/or by setting the sputtering power to be high in a case in which the seed layer is formed by a sputtering method. When the plating current density is increased, a metal film having a high internal stress grows first. This internal stress acts as a driving force to promote recrystallization of the metal film, and thus the crystallinity can be increased, and a metal film having a large crystal grain size can be formed. Furthermore, when the seed layer is deposited with a high sputtering power, the seed layer becomes heated, and thus the recrystallization of the seed layer is promoted, and the crystallinity is improved. By forming a seed layer having a high crystallinity, it becomes possible to form a metal film having a high crystallinity, that is, a large crystal grain size, on the seed layer.

### <Design of Current Collector>

In the present embodiment, it is preferable to include a step of designing the yield stress and the thickness of each of the layers constituting the laminated structure of the current collector such that the yield stress σY1 of the current collector is smaller than the tensile fracture stress σB2 of the resin layer.

The yield stress σY1 of the current collector may be obtained as the sum of “thickness proportion a×yield stress σY” of each of the layers constituting the current collector. The “thickness proportion a” is a proportion of the thickness of each layer to the total thickness of a plurality of layers (including the metal layer 30 and the resin layer 20 shown in FIGS. 1, 2, and the like) constituting the current collector. In the design step, a layer that is thinner than the other layer (a layer having a small thickness proportion a) among the layers constituting the current collector may be ignored.

As the value of the tensile fracture stress σB2 of the resin layer, for example, a value measured by a tensile test may be used. In that case, the design step may include a step of measuring the tensile fracture stress σB2 of the resin layer.

The design step may include a step of designing the yield stress σY3 of the metal layer on the basis of the half-value width β of the X-ray diffraction peak having the highest intensity in the X-ray diffraction pattern of the metal layer. In this case, the design step may include a step of deriving a relational expression between the yield stress σY3 and the half-value width β of the metal layer. The method of deriving the relational expression is the same as that described above with reference to FIG. 3.

Alternatively, the crystal grain size (or the crystallite size) of the metal layer 30 may be measured by a method other than the X-ray diffraction method, and the yield stress σY3 of the metal layer may be designed on the basis of the measured crystal grain size.

### Examples and Comparative Examples

Current collectors of examples and comparative examples were produced, and the fracture elongation of each of the current collectors was evaluated.

### <Production of Sample>

As the current collectors of Examples 1 to 9 and Comparative Examples 1 to 4, current collectors 102 having the structure shown in FIG. 2 were produced by the following method.

First, the resin layer 20 (width: 500 mm, length: 100 m) was prepared. In Examples 1 to 8 and Comparative Examples 1 to 3, a polyethylene terephthalate (PET) film (Diafoil K880, manufactured by Mitsubishi Chemical Polyester Film Co., Ltd.) was used as the resin layer 20, and in Example 9 and Comparative Example 4, a polypropylene (PP) film (4X-2172, manufactured by Toray Industries, Inc.) was used. Table 1 shows the thickness D2 of the resin layer 20 in each of the examples and comparative examples.

Next, a copper layer having a thickness of 50 nm was formed as a seed layer on each of the first surface 20a and the second surface 20b of the resin layer 20 by sputtering. Here, the temperature of the base material (the resin layer 20) during sputtering was set to room temperature when the base material was a PET film and to −20° C. when the base material was a PP film. Thereafter, copper layers were formed as the first metal layer 31 and the second metal layer 32 on the seed layers on a side of the first surface 20a and a side of the second surface 20b of the resin layer 20, respectively, by electrolytic plating. Here, the plating temperature was set to 40° C. In this manner, the current collectors of Examples 1 to 9 and Comparative Examples 1 to 4 were obtained.

Table 1 shows the sputtering power (the film formation power) when forming the seed layer, the plating current density when forming the first metal layer 31 and the second metal layer 32, and the total thickness D3 of the first metal layer 31 and the second metal layer 32 for each of the examples and comparative examples. In each current collector, the thickness of each of the first metal layer 31 and the second metal layer 32 was set to ½ of the total thickness D3.

TABLE 1

| | | | | | | | | | | Proportion | | |
|---|---|---|---|---|---|---|---|---|---|---|---|---|
| | | | | | | | | | Tensile | B of test | | |
| | | | | | | Yield | Yield | Yield | fracture | samples | | |
| | | Thickness | Thickness | | Half- | stress | stress | stress | stress | having | | |
| | | D2 of | D3 of | Thickness | value | σY3 of | σY1 of | σY2 of | σB2 of | fracture | | Plating |
| | Material | resin | metal | proportion | width β | metal | current | resin | resin | elongation | Sputtering | current |
| | of resin | layer | layer | A of metal | of metal | layer | collector | layer | layer | of 6% or | power | density |
| | layer | [μm] | [μm] | layer [—] | layer [°] | [Mpa] | [Mpa] | [Mpa] | [Mpa] | less [%] | [kW] | [A/dm²] |
| Example 1 | PET | 4.5 | 1.0 | 0.18 | 0.20 | 632 | 205 | 110 | 225 | 5.0 | 3 | 2 |
| Example 2 | PET | 4.5 | 2.0 | 0.31 | 0.09 | 390 | 196 | 110 | 225 | 2.5 | 3 | 3 |
| Example 3 | PET | 3.0 | 0.4 | 0.12 | 0.33 | 841 | 196 | 110 | 225 | 5.0 | 1 | — |
| Example 4 | PET | 6.0 | 3.0 | 0.33 | 0.09 | 390 | 203 | 110 | 225 | 7.5 | 3 | 3 |
| Example 5 | PET | 4.5 | 0.1 | 0.02 | 0.25 | 719 | 123 | 110 | 225 | 2.5 | 1 | — |
| Example 6 | PET | 4.5 | 3.6 | 0.44 | 0.08 | 362 | 223 | 110 | 225 | 17.5 | 3 | 3.5 |
| Example 7 | PET | 4.5 | 3.1 | 0.41 | 0.08 | 362 | 213 | 110 | 225 | 12.5 | 3 | 3.5 |
| Example 8 | PET | 4.5 | 1.0 | 0.18 | 0.26 | 735 | 224 | 110 | 225 | 20.0 | 1 | 2 |
| Example 9 | PP | 6.0 | 2.0 | 0.25 | 0.11 | 442 | 141 | 40 | 150 | 15.0 | 3 | 3 |
| Comparative | PET | 4.5 | 1.2 | 0.21 | 0.31 | 812 | 258 | 110 | 225 | 67.5 | 1 | 1 |
| Example 1 | | | | | | | | | | | | |
| Comparative | PET | 4.5 | 3.6 | 0.44 | 0.22 | 668 | 358 | 110 | 225 | 75.0 | 3 | 2 |
| Example 2 | | | | | | | | | | | | |
| Comparative | PET | 4.5 | 4.0 | 0.47 | 0.26 | 735 | 404 | 110 | 225 | 80.0 | 1 | 2 |
| Example 3 | | | | | | | | | | | | |
| Comparative | PP | 4.5 | 1.0 | 0.18 | 0.25 | 719 | 163 | 40 | 150 | 47.5 | 1 | 2 |
| Example 4 | | | | | | | | | | | | |

### <Measurement of Yield Stress σY2 and Tensile Fracture Stress σB2 of Resin Layer 20>

A PET film and a PP film used as the resin layer 20 in the examples and comparative examples were subjected to a tensile test in accordance with the above-mentioned JIS standard to obtain the yield stress σY2 and the tensile fracture stress σB2 of each film. The yield stress σY2 and the tensile fracture stress σB2 of each resin layer 20 are shown in Table 1.

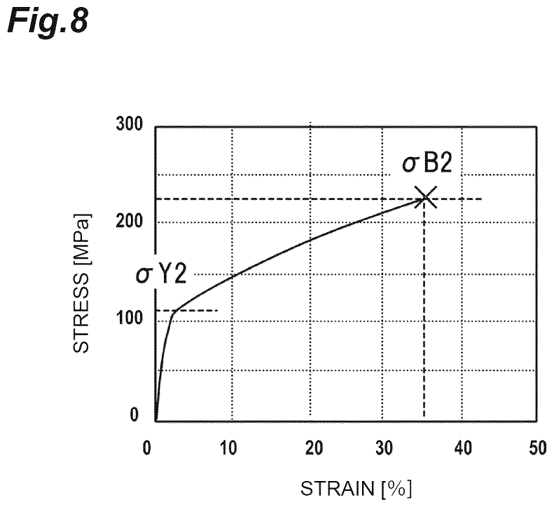

FIG. 8 is a diagram showing an example of a stress-strain curve of the PET film used in the current collectors of Examples 1 to 8 and Comparative Examples 1 to 3. From FIG. 8, it can be seen that the yield stress σY2 of the PET film is about 110 MPa, and the tensile fracture stress σB2 of the PET film is about 225 MPa. In the example shown in FIG. 8, the fracture elongation is about 35%, but the fracture elongation of the PET film varies for each measured sample and is generally within the range of 25% to 35%.

### <Measurement of Half-Value Width β>

The half-value width β of the metal layer 30 of each current collector was obtained by the X-ray diffraction method. The results are shown in Table 1.

From the measurement results, it is found that the higher the plating current density and the higher the sputtering power during the seed layer formation, the smaller the half-value width β, and that the crystallinity of the metal layer 30 can be controlled by these conditions. It is considered that the reason for this is because, as mentioned above, by setting the plating current density to be high, a metal film (here, a copper film) having a large internal stress grows, and the recrystallization of the metal film proceeds with the internal stress as a driving force, and thus the crystallinity is improved, and a metal film having a small half-value width β is obtained. In addition, it is considered that the reason for this is because, by setting the sputtering power to be high when forming the seed layer (here, the copper film), thermal recrystallization proceeds in the deposited seed layer, and a seed layer having a large crystal grain size is obtained. By increasing the crystal grain size of the seed layer, a metal film having a large crystal grain size can be grown on the seed layer.

### <Calculation of Yield Stress σY1 of Current Collector>

The yield stress σY3 of the metal layer 30 of each current collector was calculated from the half-value width β obtained by the X-ray diffraction method and the above-mentioned expression (3). Subsequently, the yield stress σY1 of each current collector was obtained by the yield stress σY3 of the metal layer 30, the yield stress σY2 of the resin layer 20, the thickness proportion A of the metal layer 30, and the above-mentioned expressions (1) and (2). The values of the obtained yield stresses σY3 and σY1 are also shown in Table 1.

As shown in Table 1, in Examples 1 to 9, the yield stress σY1 of the current collector was smaller than the tensile fracture stress σB2 (225 MPa) of the resin layer 20, and in Comparative Examples 1 to 4, the yield stress σY1 of the current collector was greater than the tensile fracture stress σB2 of the resin layer 20.

### <Method for Evaluating Fracture Elongation of Current Collector>

The fracture elongation of each current collector was evaluated by a tensile test.

First, 40 test samples were cut out from the current collector of Example 1. Here, in order to suppress a thickness variation between the test samples, sampling was performed from a portion of the current collector having a width of 500 mm, excluding a region within 50 mm from an edge (an edge region). The edge region is a region that is typically removed during battery manufacturing.

Next, the tensile test was carried out on each test sample to obtain the fracture elongation. The tensile test was carried out in accordance with the provisions of JIS K 7127:1999. Next, a proportion B of the test samples having a fracture elongation of 6% or less out of the 40 test samples was obtained.

$$B = \{ ( the number of test samples having fracture elongation of 6 \% or less ) \text{} / 40 \} \times 100$$

Similarly, for each of the current collectors of the other examples and comparative examples, a tensile test was carried out on 40 test samples, and a proportion B of the test samples having a fracture elongation of 6% or less was obtained.

The reason for using 6% as a reference is that in a case in which the resin layer 20 hardly elongates after the fracture occurs in the metal layer 30 (see FIG. 4C), the fracture elongation of the current collector becomes approximately 3% to 5%, which is the fracture elongation of the metal layer, and is considered to be 6% or less. In a case in which the resin layer 20 further elongates after the fracture occurs in the metal layer 30 (see FIG. 5C), the fracture elongation of the current collector becomes significantly greater than the fracture elongation of the metal layer, ideally becomes close to the fracture elongation of the resin layer 20, and is considered to be more than 6%.

### <Evaluation Results>

### Proportion B

Table 1 shows the proportion B obtained by the tensile test on the test sample of each current collector.

From the results shown in Table 1, it was confirmed that in the current collectors of Examples 1 to 9, the proportion B was suppressed to 20% or less, regardless of the thickness D3 of the metal layer or the material of the resin layer. In a current collector having a proportion B of 20% or less, the current collector as a whole has a predetermined elongation rate (fracture elongation), but it is considered that due to material factors, or the like, regions having a low elongation rate (that are relatively minute) are discretely present. In other words, each of the minute regions having a low elongation rate is surrounded by regions having a predetermined elongation rate. Since the stress applied to the current collector during calendering treatment or the like is dispersed to the regions surrounding the region having a low elongation rate, if the proportion B is 20% or less, the fracture of the current collector is unlikely to occur, and it is considered that the process defect rate can be reduced. For the same reason, it is considered that the fracture of the current collector can also be suppressed during operation of the battery. Therefore, in a case in which a battery is manufactured using the current collectors of Examples 1 to 9, the process defect rate during the transportation or calendering treatment of the current collectors can be significantly reduced.

As the above material factors, for example, it is considered that a portion in which a filler has agglomerated is present in the resin layer 20, or a portion in which recrystallization has been inhibited due to the segregation of impurities is present in the metal layer 30, and thus regions having a low elongation rate may occur locally in the current collector.

On the other hand, in Comparative Examples 1 to 4 in which the tensile fracture stress σB2 of the resin layer 20 was greater than the yield stress σY1 of the current collector, the proportion B exceeded 45%, which was significantly higher than the proportion B in the examples. In other words, in the current collectors of Comparative Examples 1 to 4, in nearly half or more than or equal to half of the test sample, after the metal layer 30 has fractured, the resin layer 20 fractures with almost no elongation. In such a current collector, a proportion of the regions having a low elongation rate is high in the surface of the current collector, and thus it is considered that the stress applied to the current collector during calendering treatment or the like may cause the current collector to fracture, thereby increasing the possibility of the process defect.

Therefore, it was confirmed that the fracture elongation of the current collector can be controlled by the relationship between the yield stress σY1 of the current collector obtained by the expressions (1) to (3) and the tensile fracture stress σB2 of the resin layer 20.

Furthermore, in the results of Table 1, for example, when the thickness D2 of the resin layer 20 is in the range of 4 μm to 6 μm and the thickness D3 of the metal layer 30 exceeds 3.0 μm or the half-value width β exceeds 0.25°, the proportion B tends to increase. For this reason, it is preferable that the thickness D3 be, for example, 3.0 μm or less and/or the half-value width β be, for example, 0.25° or less. On the other hand, from the viewpoint of reducing the sheet resistance of the current collector, the thickness D3 of the metal layer 30 is preferably, for example, 0.1 μm or more. For example, in the current collectors of Examples 1 and 2, which satisfy all of the following requirements: thickness D2 of resin layer 20: 4 μm or more and 6 μm or less, thickness D3 of metal layer 30: 0.1 μm or more and 3.0 μm or less, and half-value width β: 0.25° or less, the proportion B is 5% or less, and it can be seen that the fracture elongation is more reliably improved. It can also be confirmed that even when the thickness of the resin layer 20 is outside the range of 4 μm to 6 μm (for example, Example 3), the yield stress σY1 can be made lower than the tensile fracture stress σB2 by appropriately setting the thickness D2 and the half-value width β of the metal layer 30, and a high fracture elongation can be realized.

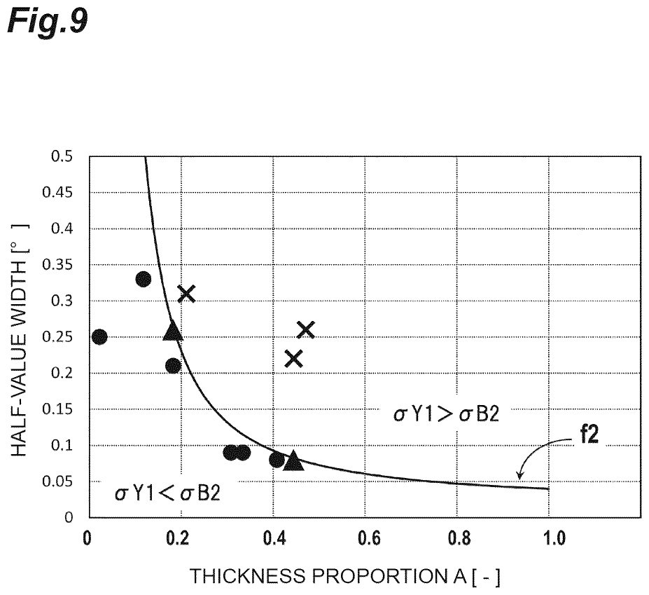

FIG. 9 is a diagram plot in which the thickness proportion A and the half-value width β of the metal layer in the current collectors of Examples 1 to 8 and Comparative Examples 1 to 3 in which a polyethylene terephthalate film was used as the resin layer 20. The proportion B that is less than 15% is represented by “●,” the proportion B that is 15% or more and 20% or less is represented by “,” and the proportion B that is more than 20% is represented by “x.” A curve f2 in FIG. 9 indicates the set of the half-value width β and the thickness proportion A when the yield stress σY1 is equal to 225 MPa, which is the tensile stress of the polyethylene terephthalate film. The region above the curve f2 is a region where σY1>σB2, and the region below the curve f2 is a region in which σY1<σB2 is satisfied.

From FIG. 9, it can be confirmed that by controlling the half-value width β and the thickness proportion A to be located in the region below the curve f2, that is, to satisfy σY1<σB2, a current collector having an excellent fracture elongation can be realized. Although not shown, when a resin film having a tensile fracture stress σB2 smaller than, for example, 225 MPa, is used as the resin layer, the curve f2 shifts downward (to a −y side), and thus the region in which σY1<σB2 is satisfied becomes narrower.

### Stress-Strain Curve

The stress-strain curves of the current collectors of the examples and the comparative examples will be explained using the current collectors of Example 1 and Comparative Example 1 as examples.

FIGS. 10A and 10B are diagrams showing examples of the measurement results of the stress-strain curves of the current collectors of Example 1 and Comparative Example 1, respectively. As can be seen from Table 1, the current collector of Example 6 and the current collector of Comparative Example 1 have substantially the same thickness D2 of the resin layer (the PET film) and thickness D3 of the metal layer.

As shown in FIG. 10A, in the current collector of Example 1, fracture occurs in the metal layer at the yield stress σY1 that is lower than the tensile fracture stress σB2 (225 MPa in this example). Even after the metal layer has fractured, the resin layer deforms (extends) in response to the stress, and thus the strain in the current collector increases (see FIG. 5C). When the stress applied to the current collector reaches the tensile fracture stress σB2 (225 MPa), the resin layer also fractures. In this example, the fracture elongation of the current collector is approximately the same as that of the resin layer, that is, about 35%.

On the other hand, as shown in FIG. 10B, in the current collector of Comparative Example 1, a fracture portion occurs in the metal layer at the yield stress σY1 that is higher than the tensile fracture stress σB2 (225 MPa in this example). Immediately after this time point (the yield point), a stress of 225 MPa or more is applied to a portion of the resin layer located below the fracture portion of the metal layer, and the resin layer fractures without elongation (see FIG. 4C). For this reason, the fracture elongation of the current collector is significantly smaller than the fracture elongation of the current collector of Example 1 shown in FIG. 10A. In this example, the fracture elongation of the current collector is about 3% to 5%.

The stress-strain curves shown in FIGS. 10A and 10B are merely examples and may vary depending on, for example, the variation in the fracture elongation of the PET film. The fracture elongation of the current collector in the example may be smaller than the fracture elongation of the resin layer. Even in this case, it is considered that the effect of suppressing occurrence of the fracture of the current collector is achieved by making the fracture elongation of the current collector be greater (here, 6% or more) than the fracture elongation of the metal layer (here, a copper layer).

### Second Embodiment

An embodiment of an electrode for a power storage device will be described. The electrode for a power storage device (hereinafter simply referred to as an “electrode”) of the present embodiment is preferably used as a negative electrode of the power storage device, but may also be used as a positive electrode thereof.

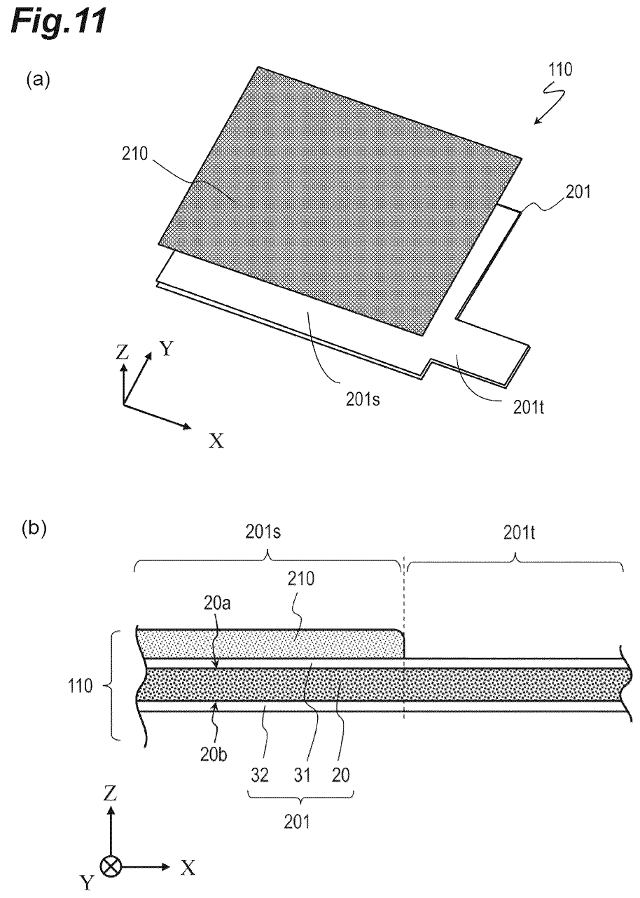

FIG. 11A is an exploded perspective view of an electrode 110, and FIG. 11B is a cross-sectional view showing a part of the electrode 110. The electrode 110 includes a current collector 201 and an active material layer 210. The active material layer 210 includes an active material that is oxidized and reduced depending on charging (or storage of electricity) and discharging. The current collector 201 supports the active material layer 210, and also supplies electrons to the active material layer 210 and receives electrons from the active material layer 210.

The current collector 201 is any one of the current collectors 101 to 104 described in the first embodiment. That is, the current collector 201 includes a resin layer 20 and a first metal layer 31 located on a side of a first surface 20a of the resin layer 20. The current collector 201 may further include a second metal layer 32 located on a side of a second surface 20b of the resin layer 20.

The current collector 201 includes a first portion 201s and a second portion 201t, and the active material layer 210 is disposed on the first portion 201s. The second portion 201t is not provided with the active material layer 210 and functions as a tab for electrical connection to the outside.

The active material layer 210 is located on a side of the first metal layer 31 opposite to the resin layer 20. The active material layer 210 includes a positive electrode active material or a negative electrode active material that occludes and releases lithium ions.

The electrode 110 of the present embodiment has desired electrical properties and includes the current collector 201 having a high fracture elongation. For this reason, it is possible to prevent the current collector from tearing due to a calendering treatment or the like when forming the active material layer 210, thereby improving the process defect rate. Furthermore, even in a case in which a large stress is applied locally to the current collector 201 due to the expansion and contraction of the active material layer 210 during the operation of the battery, deformation of the battery and deterioration of its characteristics caused by the fracture of the current collector 201 can be suppressed.

The electrode 110 for a positive electrode or negative electrode can be manufactured by a known manufacturing method.

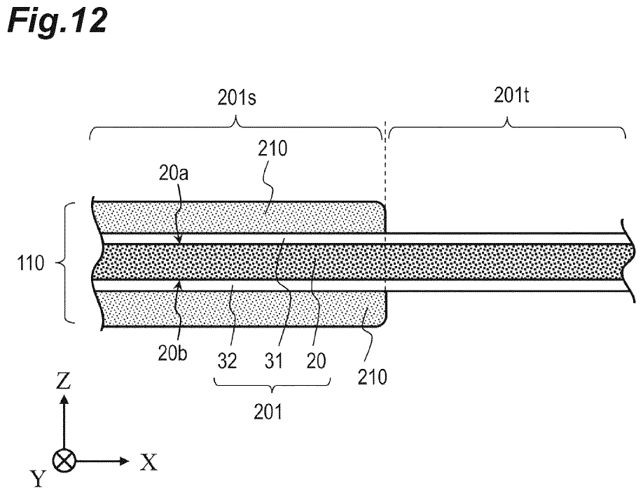

The structure of the electrode for a power storage device of the present embodiment is not limited to the structure shown in FIGS. 11A and 11B. For example, as shown in FIG. 12, the active material layer 210 may be disposed on a side of the second metal layer 32 opposite to the resin layer 20.

### <Active Material Layer 210>

In a case in which the electrode 110 is used as a positive electrode of the power storage device, the active material layer 210 includes a positive electrode active material.

The positive electrode active material includes, for example, a composite metal oxide including lithium. Examples of the composite metal oxide including lithium include lithium cobalt oxide (LiCoO₂), lithium nickel oxide (LiNiO₂), lithium manganese oxide (LiMnO₂), lithium manganese spinel (LiMn₂O₄), a lithium vanadium compound (LiV₂O₅), olivine type LiMPO₄ (wherein M is one or more elements selected from the group consisting of Co, Ni, Mn, Fe, Mg, Nb, Ti, Al, and Zr, or vanadium oxide), lithium titanate (Li₄Ti₅O₁₂), a composite metal oxide represented by a general formula: LiNiₓCo_{y}Mn_{z}MₐO₂ (x+y+z+a=1, 0≤x<1, 0≤y<1, 0≤z<1, 0≤a<1, where M in the general formula is one or more elements selected from the group consisting of Al, Mg, Nb, Ti, Cu, Zn, and Cr), a composite metal oxide represented by a general formula: LiNiₓCo_{y}Al_{z}O₂ (0.9<x+y+z<1.1), and the like. The positive electrode active material may include polyacetylene, polyaniline, polypyrrole, polythiophene, polyacene, or the like as a material capable of occluding and releasing lithium ions.

The active material layer 210 used for the positive electrode may further include at least one of a binder and a conductive assistant. As the binder, various known materials can be used. As the binder in the active material layer 210 used for the positive electrode, a fluororesin such as polyvinylidene fluoride (PVDF), polytetrafluoroethylene (PTFE), a tetrafluoroethylene-hexafluoropropylene copolymer (FEP), a tetrafluoroethylene-perfluoroalkylvinyl ether copolymer (PFA), an ethylene-tetrafluoroethylene copolymer (ETFE), polychlorotrifluoroethylene (PCTFE), an ethylene-chlorotrifluoroethylene copolymer (ECTFE), or polyvinyl fluoride (PVF) can be used.

As the binder, vinylidene fluoride-based fluororubber may be used. For example, vinylidene fluoride-hexafluoropropylene-based fluororubber (VDF-HFP-based fluororubber), vinylidene fluoride-hexafluoropropylene-tetrafluoroethylene-based fluororubber (VDF-HFP-TFE-based fluororubber), vinylidene fluoride-pentafluoropropylene-based fluororubber (VDF-PFP-based fluororubber), vinylidene fluoride-pentafluoropropylene-tetrafluoroethylene-based fluororubber (VDF-PFP-TFE-based fluororubber), vinylidene fluoride-perfluoromethylvinyl ether-tetrafluoroethylene-based fluororubber (VDF-PFMVE-TFE-based fluororubber), vinylidene fluoride-chlorotrifluoroethylene-based fluororubber (VDF-CTFE-based fluororubber), or the like may be applied as the binder of the active material layer 210 used for the positive electrode.

Examples of the conductive assistant include a carbon material such as carbon powder or a carbon nanotube. As the carbon powder, carbon black or the like can be applied. Other examples of the conductive assistant for the active material layer 210 used for the positive electrode include powder of a metal such as nickel, stainless steel, or iron, and powder of a conductive oxide such as ITO. Two or more of the above-mentioned materials may be mixed with each other and included in the active material layer 210.

In a case in which the electrode 110 is used as a negative electrode of the power storage device, the active material layer 210 used for the negative electrode includes a negative electrode active material.

The negative electrode active material includes a carbon material. Examples of the carbon material include natural or artificial graphite, a carbon nanotube, non-graphitizable carbon, easily graphitizable carbon (soft carbon), low-temperature fired carbon, and the like. The negative electrode active material may include a material other than the carbon material. For example, the negative electrode active material may include particles of an alkali metal such as metallic lithium, an alkaline earth metal, a metal such as tin or silicon that can form a compound with a metal such as lithium, a silicon-carbon composite material, an amorphous compound mainly composed of an oxide (SiOₓ (0<x<2), tin dioxide, or the like), lithium titanate (Li₄Ti₅O₁₂), or the like.

As the binder and conductive assistant of the active material layer 210 used for the negative electrode, the binder and conductive assistant described above can be similarly used. As the binder for the negative electrode, cellulose, styrene-butadiene rubber, ethylene-propylene rubber, polyimide, polyamide-imide, acrylic resin, or the like may be used.

### Third Embodiment

An embodiment of a lithium ion secondary battery will be described.

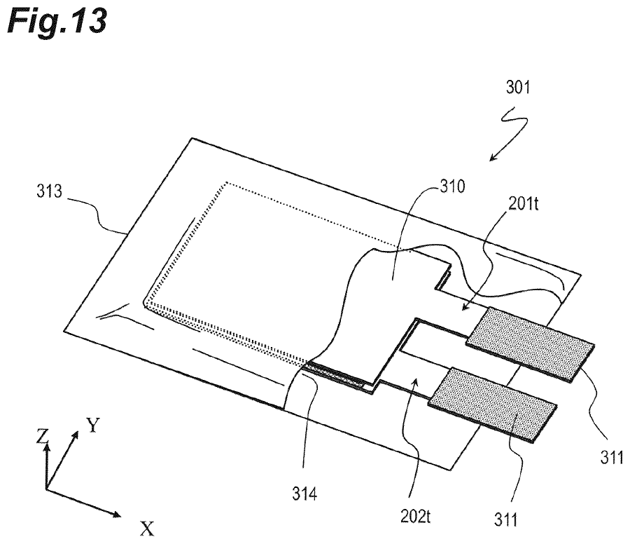

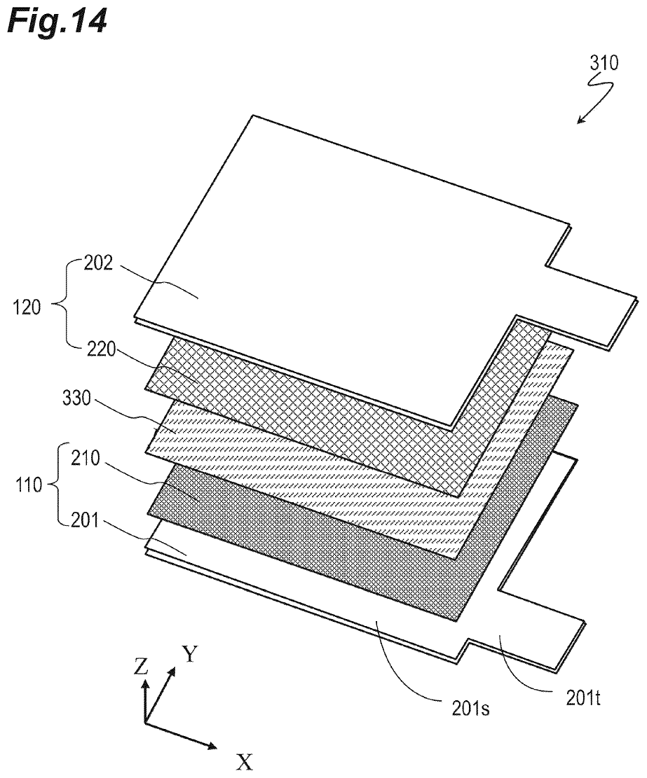

FIG. 13 is a schematic external view showing an example of a lithium ion secondary battery 301, and FIG. 14 is an exploded perspective view showing a cell taken out from the lithium ion secondary battery shown in FIG. 13. Here, as the lithium ion secondary battery, a so-called pouch type or laminate type lithium ion secondary battery is exemplified. The shown lithium ion secondary battery is of a single layer type, but may be of a laminated type. In the shown example, a positive electrode, a separator, and a negative electrode that constitute the cell are laminated in the Z direction in the figure.

The lithium ion secondary battery 301 includes a cell 310, a pair of leads 311 connected to the cell 310, an exterior body 313 that covers the cell 310, and an electrolyte 314.

The cell 310 includes an electrode 110, an electrode 120, and a separator 330 disposed therebetween. In the shown example, the cell 310 is a single layer cell that includes a pair of electrodes.

One of the electrode 110 and the electrode 120 is formed as a positive electrode including a positive electrode active material, and the other thereof is formed as a negative electrode including a negative electrode active material. The electrode 110 is the electrode 110 described in the third embodiment, and is formed as, for example, a negative electrode.

The electrode 120 includes a current collector 202 and an active material layer 220 disposed on one surface of the current collector 202.

The active material layer 220 is a layer including the negative electrode active material or the positive electrode active material described in the second embodiment. The current collector 202 may have a laminated structure including a resin layer and a metal layer disposed on one or both surfaces of the resin layer, similar to the current collectors 101 to 104 described in the first embodiment, for example. The material and thickness of the resin layer and/or metal layer in the current collector 202 may be different from those in the electrode 110. Alternatively, the current collector 202 may be a metallic current collector made of a metal foil.

The separator 330 is an insulating porous material. For example, a monolayer film or laminated film of polyolefin such as polyethylene or polypropylene, a nonwoven fabric of a fiber or porous film of at least one selected from the group consisting of cellulose, polyester, polyacrylonitrile, polyimide, polyamide (for example, aromatic polyamide), polyethylene, and polypropylene, or the like can be used as the separator.

The electrolyte 314 is disposed in the space inside the exterior body 313. The electrolyte 314 is a non-aqueous electrolyte including lithium ions, for example, a non-aqueous electrolytic solution including lithium ions. In a case in which the non-aqueous electrolytic solution is applied to the electrolyte 314, a sealant (for example, a resin film of polypropylene or the like, not shown in FIG. 13) is typically disposed between the exterior body 313 and the lead 311 to prevent leakage of the non-aqueous electrolytic solution.

For example, a non-aqueous electrolytic solution including a metal salt such as a lithium salt and an organic solvent can be used as the electrolyte 314. For example, LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB, or the like can be used as the lithium salt. These lithium salts may be used alone or in combination of two or more.

For example, a cyclic carbonate or a chain carbonate can be uses as the solvent for the electrolyte 314. Specifically, ethylene carbonate, propylene carbonate, butylene carbonate, dimethyl carbonate, or the like can be used.

The lithium ion secondary battery 301 can be manufactured, for example, by the following method. After the electrodes 110 and 120 have been produced, the electrode 110 and the electrode 120 are held with the separator 330 interposed therebetween such that the active material layers 210 and 220 oppose each other, thereby forming the cell 310. The obtained cell 310 is inserted into the space in the exterior body 313. The electrolyte 314 is disposed in the space in the exterior body 313, and the exterior body 313 is sealed, thereby completing the lithium ion secondary battery 301.

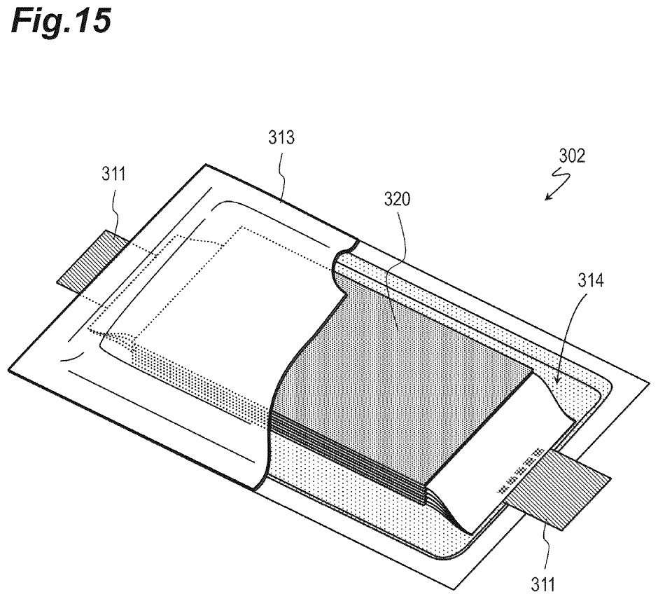

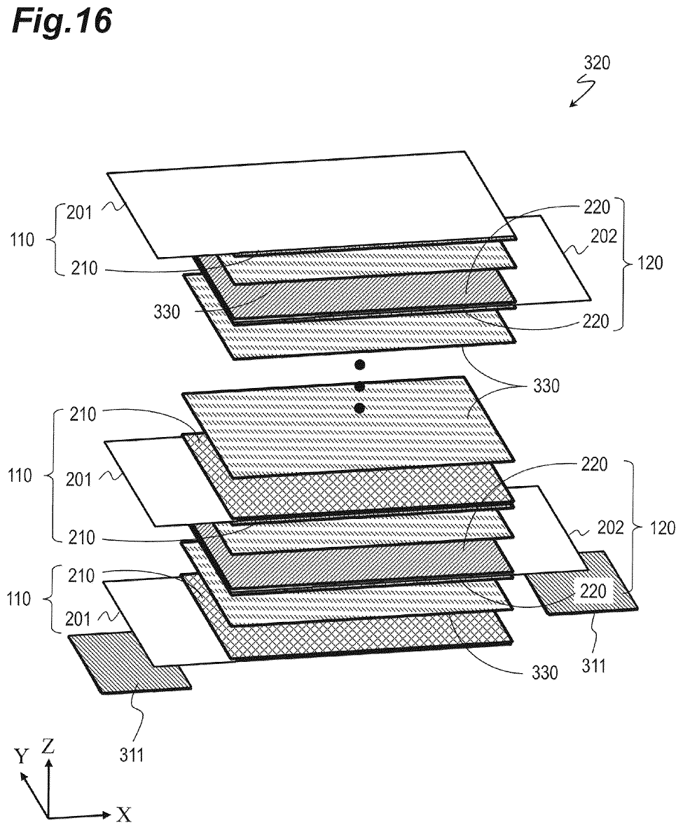

FIG. 15 is a schematic external view showing another lithium ion secondary battery 302 according to the present embodiment, and FIG. 16 is an exploded perspective view showing a cell taken out from the lithium ion secondary battery shown in FIG. 15. The lithium ion secondary battery 302 differs from the lithium ion secondary battery 301 shown in FIG. 13 in that the lithium ion secondary battery 302 has a laminated cell 320.

The cell 320 includes a plurality of electrodes 110, a plurality of electrodes 120, and a plurality of separators 330. The cell 320 has a structure in which the electrode 110 and the electrode 120 are alternately laminated with a separator 330 interposed therebetween. One of the electrode 110 and the electrode 120 is a positive electrode, and the other thereof is a negative electrode. In this example, the electrode 110 is the electrode 110 described in the second embodiment, and is preferably formed as a negative electrode.

Each electrode 110 can have the structure described above with reference to FIG. 12. Each electrode 120 includes a current collector 202 and active material layers 220 disposed on the upper surface and the lower surface of the current collector 202. As described with reference to FIG. 14, the current collector 202 may have a laminated structure including a resin layer and metal layers located on both surfaces of the resin layer, or may be a metal current collector made of a metal foil.

The power storage device to which the electrode of the present embodiment can be applied is not limited to a lithium ion secondary battery. The electrode of the present embodiment can also be suitably used in, for example, an electric double layer capacitor, or the like.

### INDUSTRIAL APPLICABILITY

The electrode for a power storage device according to the embodiment of the present disclosure is useful for a power source for various electronic devices, electric motors, and the like. The power storage device according to the embodiment of the present disclosure can be applied, for example, to a power source for a vehicle such as bicycle and a passenger car, a power source for a communication device such as a smartphone, a power source for various sensors, and a power source for driving an unmanned extended vehicle (UxV).

### REFERENCE SIGNS LIST

20 Resin layer
20a First surface of resin layer
20b Second surface of resin layer
21 Portion of resin layer
30 Metal layer
31 First metal layer
31a First surface of first metal layer
31b Second surface of first metal layer
32 Second metal layer
32a First surface of second metal layer
32b Second surface of second metal layer
41 First intervening layer
42 Second intervening layer
101, 102, 103, 104 Current collector
110, 120 Electrode for power storage device
131 Necked portion
132 Fracture portion
201, 202 Current collector
201s First portion of current collector
201t Second portion of current collector
202 Current collector
210, 220 Active material layer
301, 302 Lithium ion secondary battery
310, 320 Cell
311 Lead
313 Exterior body
314 Electrolyte
330 Separator

1. A current collector comprising:
a resin layer having a first surface and a second surface located on a side opposite to the first surface; and
a metal layer including copper,
wherein the metal layer includes a first metal layer located on a side of the first surface of the resin layer,
wherein a yield stress σY1 of the current collector is smaller than a tensile fracture stress σB2 of the resin layer,
wherein the yield stress σY1 [MPa] of the current collector is a value obtained by the following expressions (1) and (2) from a yield stress σY2 [MPa] of the resin layer, a thickness D2 [μm] of the resin layer, a yield stress σY3 [MPa] of the metal layer, and a thickness D3 [μm] of the metal layer, and
$$σ Y 1 = A \times σ Y 3 + ( 1 - A ) \times σ Y 2 \qquad ( 1 )$$
$$A = D 3 / ( D 2 + D 3 ) \qquad ( 2 )$$
wherein the yield stress σY3 [MPa] of the metal layer is a value obtained by the following expression (3) from a half-value width β [°] of an X-ray diffraction peak having the highest intensity in an X-ray diffraction pattern of the metal layer.
$$σ Y 3 = ( - 103 + 16 \; 44 \times √ β ) \qquad ( 3 )$$

2. The current collector according to claim 1, wherein the metal layer further includes a second metal layer located on a side of the second surface of the resin layer.

3. The current collector according to claim 1, wherein the metal layer includes copper as a main component.

4. The current collector according to claim 1, wherein the thickness D2 of the resin layer is 4 μm or more and 6 μm or less.

5. The current collector according to claim 1, wherein the thickness D3 of the metal layer is 0.1 μm or more and 3 μm or less.

6. The current collector according to claim 1, wherein the half-value width β is 0.25° or less.

7. The current collector according to claim 1, wherein the thickness D2 of the resin layer and the thickness D3 of the metal layer satisfy the following expression.
$$0.02 ≦ D 3 / ( D 2 + D 3 ) ≦ 0.44$$

8. The current collector according to claim 1, further comprising an intervening layer between the first surface of the resin layer and the first metal layer, the intervening layer including a metal other than copper as a main component.

9. The current collector according to claim 1, wherein the resin layer includes at least any one of polyethylene terephthalate, polyimide, polypropylene, polycarbonate, polyamide, and polyvinyl chloride.

10. An electrode for a power storage device comprising:
a current collector according to claim 1; and
an active material layer located on a side of the metal layer opposite to the resin layer.

11. A lithium ion secondary battery comprising:
a positive electrode;
a negative electrode;
a separator disposed between the negative electrode and the positive electrode; and
a non-aqueous electrolyte including lithium ions,
wherein the negative electrode is the electrode for a power storage device according to claim 10.

12. A method for manufacturing a current collector that has a laminated structure that includes a resin layer and a metal layer including copper, the method comprising a step of designing a yield stress and a thickness of each of layers constituting the laminated structure such that a yield stress σY1 of the current collector is smaller than a tensile fracture stress σB2 of the resin layer.

13. The method for manufacturing a current collector according to claim 12, wherein the step of designing includes a step of designing a yield stress σY3 of the metal layer on the basis of a crystal grain size of the metal layer or a half-value width β of an X-ray diffraction peak having the highest intensity in an X-ray diffraction pattern of the metal layer.

14. The method for manufacturing a current collector according to claim 13, wherein the step of designing a yield stress σY3 of the metal layer includes a step of deriving a relational expression between the yield stress σY3 of the metal layer and the half-value width β.

15. The method for manufacturing a current collector according to claim 13, wherein, in the step of designing a yield stress σY3 of the metal layer, the yield stress σY3 [MPa] of the metal layer is designed on the basis of the half-value width β [°] and the following expression.
$$σ Y 3 = ( - 103 + 16 \; 44 \times √ β )$$
